(19) United States
(12) Patent Application Publication
(10) Pub. No.: US 2025/0061464 A1
(43) Pub. Date: Feb. 20, 2025

(54) Bridging End User Customer Support and Cloud Operator Customer Support

(71) Applicant: Oracle International Corporation, Redwood Shores, CA (US)

(72) Inventors: Shankar Balassoubramanien, Aldie, VA (US); Ole Bore, Leavenworth, WA (US); Manik Gangopadhyay, Mountain House, CA (US); Suining Liang, Redwood City, CA (US); Sneha Modi, Des Plaines, IL (US); Milind Khairnar, Bellevue, WA (US); Galina Ryjkov, Allen, TX (US); Kasi Viswanath Vaddadi, Hyderabad (IN); Molly A Sullivan, Seattle, WA (US); Jet Wilda, Manitowoc, WI (US); Daniel M. Vogel, Seattle, WA (US); Jayesh Gangadharan, Seattle, WA (US); Monty Bucholz, Bozeman, MT (US)

(73) Assignee: Oracle International Corporation, Redwood Shores, CA (US)

(21) Appl. No.: 18/402,972

(22) Filed: Jan. 3, 2024

Related U.S. Application Data
(60) Provisional application No. 63/519,547, filed on Aug. 14, 2023.

(51) Int. Cl. G06Q 30/015

(52) U.S. Cl. CPC G06Q 30/015

(57) ABSTRACT

Techniques for escalating a service ticket between two service providers include receiving an initial service ticket at an initial service provider for resolution of an issue from an affected entity that is affected by the issue. The initial service ticket comprises an access-restricted set of attributes of the affected entity. Based on the initial service ticket, the system generates an escalated service ticket at the initial service provider. The escalated service ticket identifies the issue and omits the access-restricted attributes. The system transmits the escalated service ticket to a higher-tiered service provider, which is not authorized to access the access-restricted set of attributes comprised in the initial service ticket. In response to transmitting the escalated service ticket, the system receives information corresponding to the resolution of the issue from the higher-tiered service provider and processes the initial service ticket based on the information corresponding to the resolution of the issue.

### INCORPORATION BY REFERENCE; DISCLAIMER

The following application is hereby incorporated by reference: Application No. 63/519,547 filed on Aug. 14, 2023. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to systems and methods for providing dedicated or private label cloud (PLC) environments for use by tenants of a cloud infrastructure environment in accessing software products, services, or other offerings associated with the environment. In particular, the present disclosure relates to receiving, at an initial service provider, an initial service ticket from an affected entity, determining that the initial service ticket requires escalation, generating an escalated ticket that does not include some access-restricted attributes of the affected entity, and submitting the escalated ticket to another service provider.

### BACKGROUND

A cloud computing environment can be used to provide access to a range of complementary cloud-based components, such as software applications or services, that enable organizations or enterprise customers to operate their applications and services in a highly available hosted environment.

The benefits to an organization in moving their application and service needs to a cloud environment include a reduction in the cost and complexity of designing, building, operating, and maintaining their own on-premise data center, software application framework, or other information technology infrastructure.

Some organizations provide computer-related services to customers, including the use of software and/or hardware that is created and/or owned by a third party. The organization may be able to provide customer support for the computer-related services in some cases. However, for other cases, the organization may need support from the third party to resolve the issue.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment.

FIG. 2 further illustrates how a cloud infrastructure environment can be used to provide cloud-based applications or services or services in accordance with an embodiment.

FIG. 3 illustrates an example cloud infrastructure architecture in accordance with an embodiment.

FIG. 4 illustrates another example of a cloud infrastructure architecture in accordance with an embodiment.

FIG. 5 illustrates another example of a cloud infrastructure architecture in accordance with an embodiment.

FIG. 6 illustrates another example of a cloud infrastructure architecture in accordance with an embodiment.

FIG. 7 illustrates how the system can provide dedicated or private label cloud environments for use by tenants or customers of a cloud infrastructure environment in accordance with an embodiment.

FIG. 8 further illustrates the use of private label cloud realms for use by tenants or customers of a cloud infrastructure environment in accordance with an embodiment.

FIG. 9 further illustrates the use of private label cloud realms for use by tenants or customers of a cloud infrastructure environment in accordance with an embodiment.

FIG. 10 illustrates a system for providing access to software products or services in a cloud computing or other computing environment in accordance with an embodiment.

FIGS. 11A-B illustrate a system in accordance with one or more embodiments.

FIG. 12 illustrates an example set of operations for escalating a service ticket to a third party in accordance with one or more embodiments.

FIG. 13 illustrates an example of a machine learning model in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DEDICATED OR PRIVATE LABEL CLOUD ENVIRONMENTS
3. SERVICE ESCALATION SYSTEM ARCHITECTURE
4. ESCALATING A SERVICE TICKET TO A THIRD PARTY
5. MACHINE LEARNING
6. PRACTICAL APPLICATIONS, ADVANTAGES, AND IMPROVEMENTS
7. MISCELLANEOUS; EXTENSIONS

### 1. GENERAL OVERVIEW

[Plain English Summary of the Claims that is Easy for Anyone to Understand]

One or more embodiments . . . .

One or more embodiments described in this Specification and/or recited in the claims may not be included in this General Overview section.

### 2. DEDICATED OR PRIVATE LABEL CLOUD ENVIRONMENTS

One or more embodiments provide features associated with dedicated or private label cloud (PLC) environments for use by tenants of a cloud infrastructure environment in accessing software products, services, or other offerings associated with the environment.

A cloud computing or cloud infrastructure environment can be used to provide access to a range of complementary cloud-based components, such as software applications or services, that enable organizations or enterprise customers to operate their applications and services in a highly available hosted environment.

The benefits to an organization in moving their application and service needs to a cloud infrastructure environment include a reduction in the cost and complexity of designing, building, operating, and maintaining their own on-premise data center, software application framework, or other information technology infrastructure.

A system may resolve a service ticket that identifies an issue affecting an “affected entity.” To resolve the ticket, the system may use information generated by a higher-tiered service provider. One or more embodiments obtain the information generated by the higher-tiered service provider for resolving the service ticket without sharing restricted-access attributes of the affected entity included in the service ticket, with the higher-tiered service provider.

The system receives an initial service ticket from a customer for a resolution of an issue. The customer is referred to as an “affected entity” as the issue affects the customer. The initial service ticket, from the customer, includes an access-restricted set of attributes corresponding to the customer. Based on the initial service ticket itself (or an intermediate service ticket generated from the initial service ticket), the system determines that the issue needs to be escalated to a higher-tiered service provider that is not permitted to access the access-restricted set of attributes corresponding to the customer. The system generates an escalated service ticket from the intermediate service ticket (or directly from the initial service ticket). The escalated service ticket identifies the issue from the initial service ticket that is to be resolved. The escalated service ticket does not include the access-restricted set of attributes corresponding to the customer that were included in the initial service ticket. The system transmits the escalated service ticket to the higher-tiered service provider for resolution of the issue. In response to the transmission of the escalated service ticket, the system receives information corresponding to the resolution of the issue. The system then processes the initial service ticket based on the information corresponding to the resolution of the issue.

One or more embodiments described in this Specification and/or recited in the claims may not be included in this General Overview section.

### Cloud Infrastructure Environments

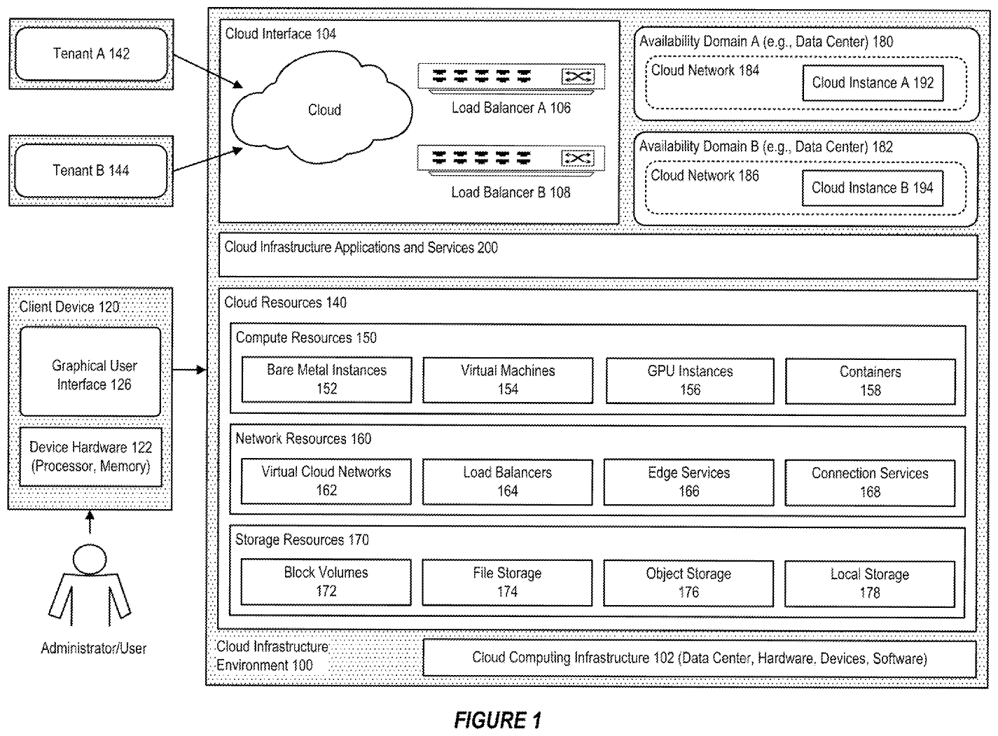

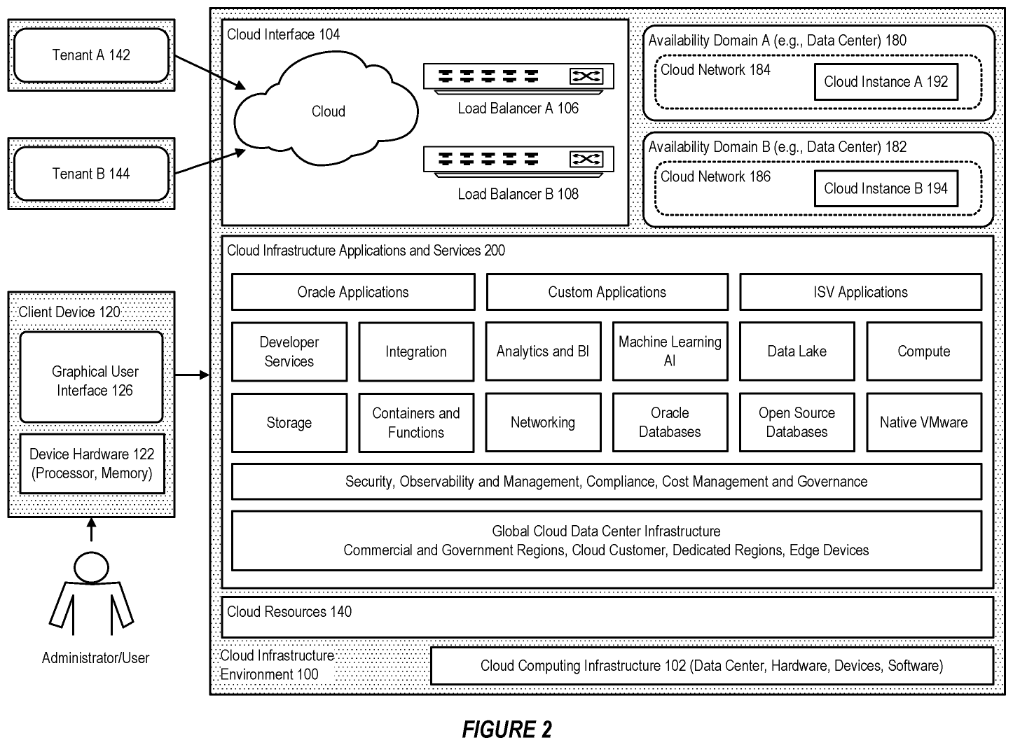

FIGS. 1 and 2 illustrate a system for providing a cloud infrastructure environment in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers which are accessible from the Internet and used for distributing external traffic, or private load balancers which are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that enable customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service enables the management of users, groups, and policies within a tenancy. Through IAM, customers can control who has access to their resources and what actions they can perform. The tenancy is also the level at which billing and subscription management are handled. All the usage and costs associated with the resources within a tenancy are tracked and billed collectively under that tenancy. Each tenancy may be associated with specific service limits and quotas for various resources. These limits may be used to help manage capacity and facilitate resource distribution across all tenants.

In accordance with an embodiment, a computing device, such as a client device 120 having a device hardware 122 (e.g., processor, memory) and graphical user interface 126, can enable an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing only the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premises data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise a number of resources, such as data/block volumes 172, file storage 174, object storage 176, and/or local storage 178. Data/block volumes 172 provide unformatted block-level storage that can be used to create file systems, to host databases or for other purposes requiring unformatted storage. File storage 174 provides a file system in an embodiment, and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that enable organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can seamlessly lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that enables the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components (example services include billing software, monitoring software, logging software, load balancing software, or clustering software). Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries, or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various geographic locations). However, in some examples, the infrastructure on which the code will be deployed requires provisioning. In some instances, the provisioning can be done manually, a provisioning tool may be utilized to provision the resources, and/or deployment tools may be utilized to deploy the code once the infrastructure is provisioned.

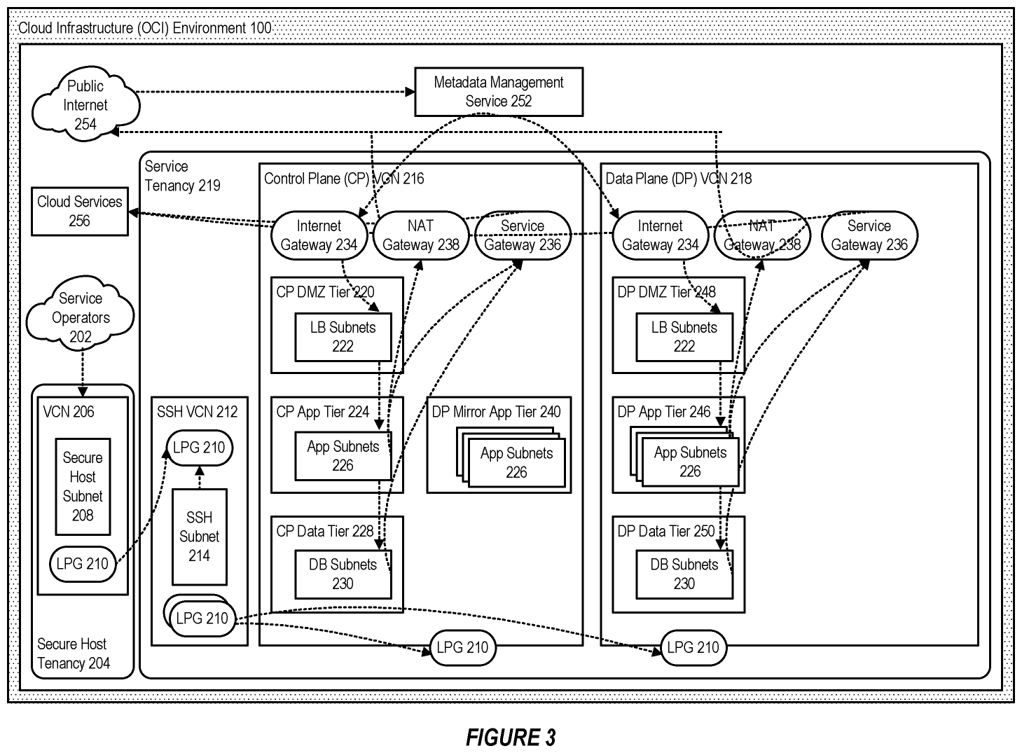

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as iOS, Android, and the like, and being Internet, e-mail, short message service (SMS), or other communication protocol enabled. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

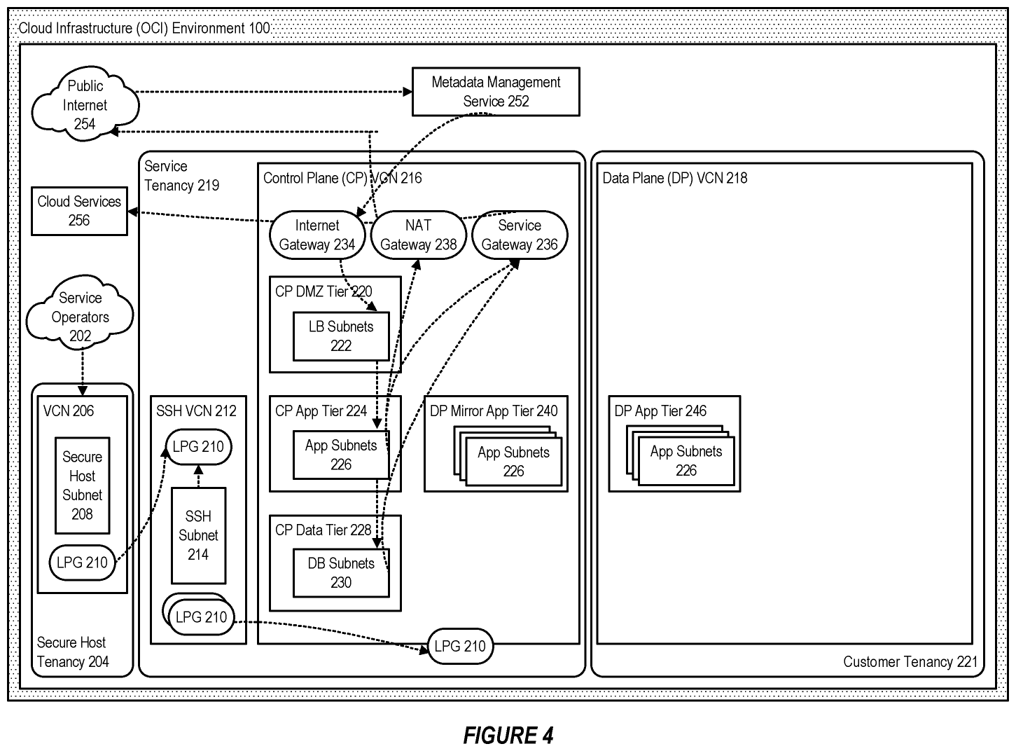

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

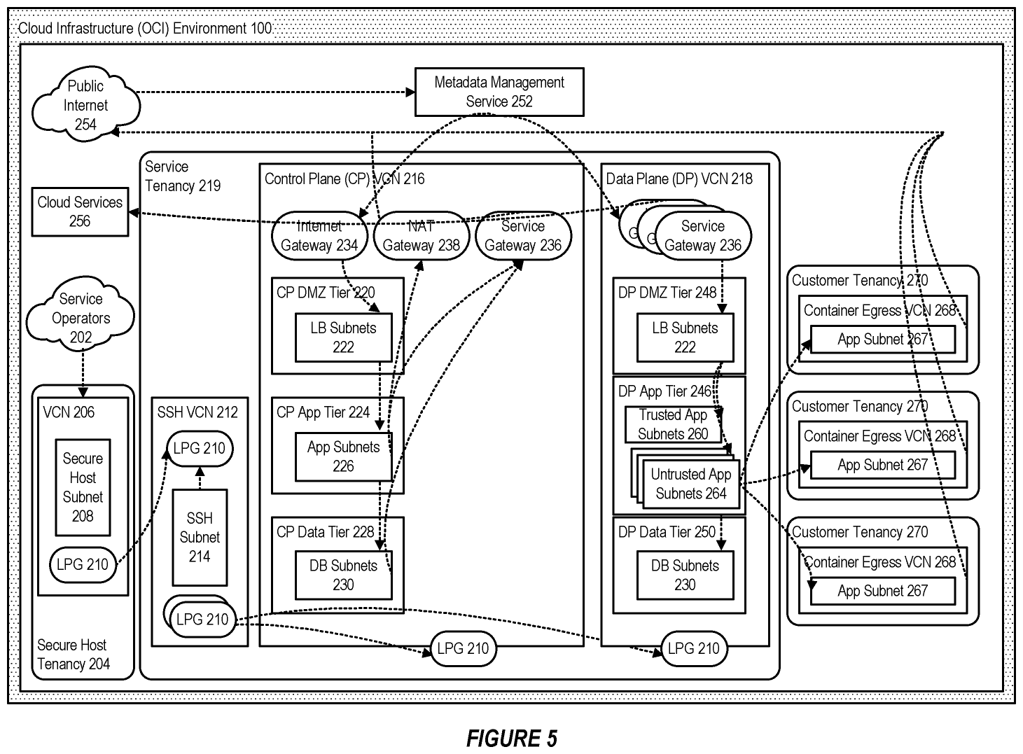

FIG. 5 illustrates another example of a cloud infrastructure architecture in accordance with an embodiment.

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

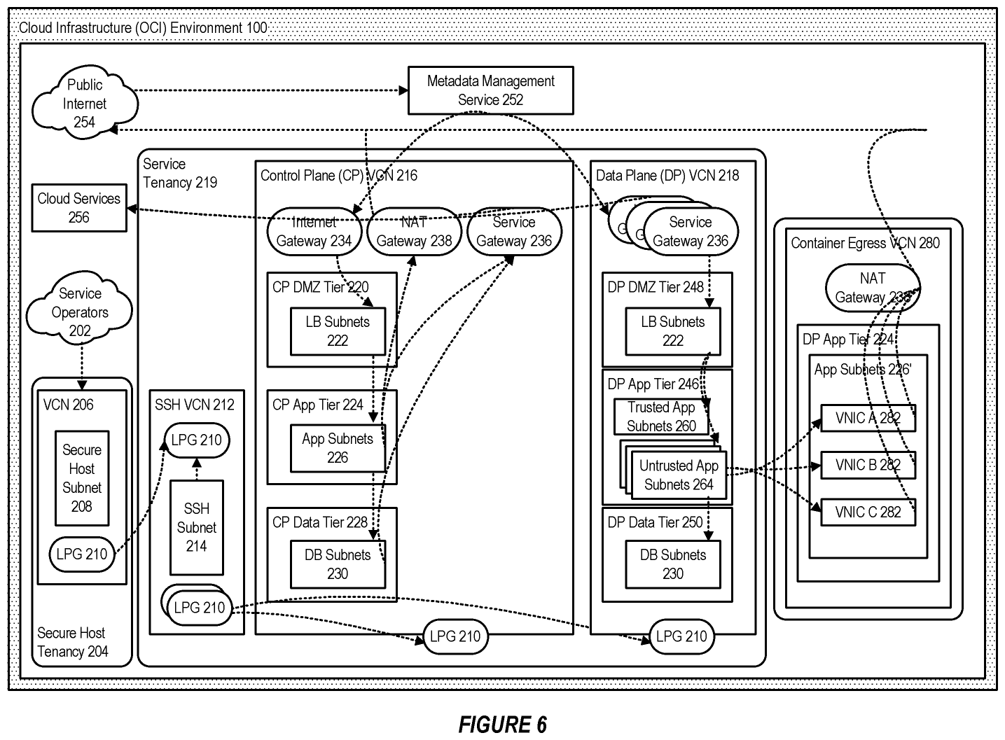

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

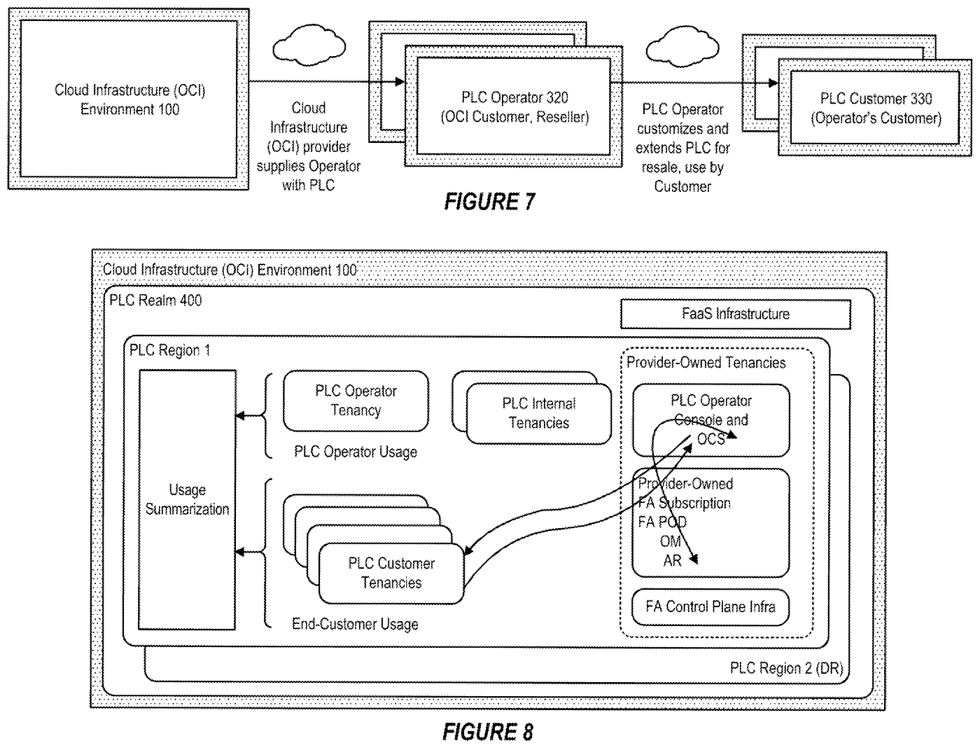

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., Oracle Cloud Infrastructure, OCI) can supply a PLC operator 320, for example an OCI customer operating as a reseller, with one or more private label cloud (PLC) environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, oracle Fusion Applications products, or other types of products or services that allow customers to subscribe to usage of those products or services.

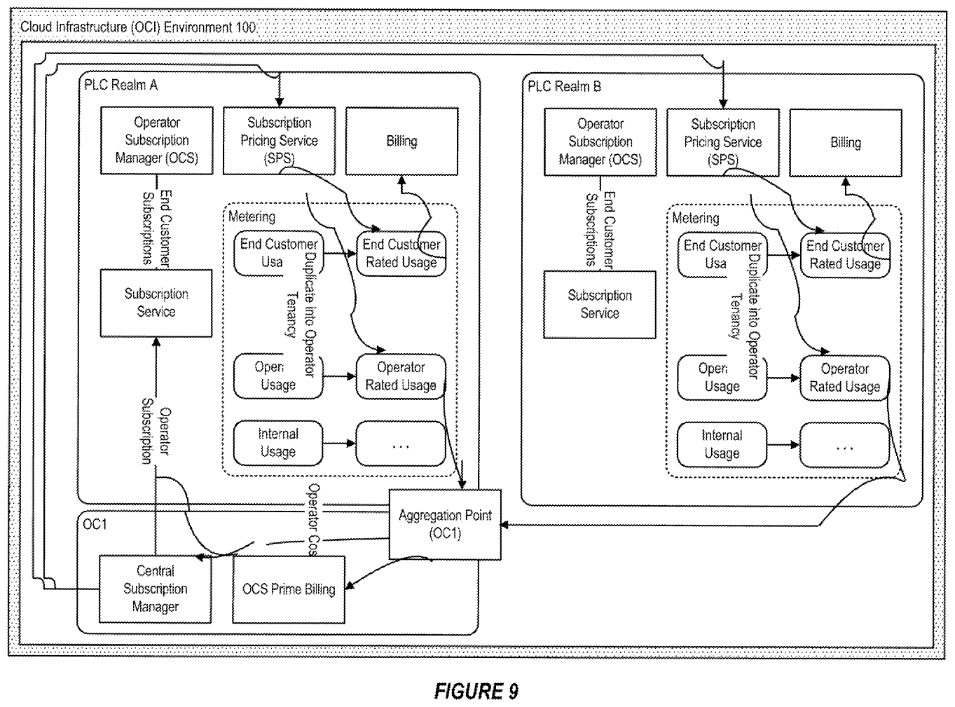

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, referred to herein in some embodiments as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator or their customer requests a private label cloud environment, the system creates a PLC realm for use within a PLC region together with one or more provider-owned tenancies. These (e.g., Oracle OCI) tenancies allow a region to function with its required service infrastructure and are administered by the cloud infrastructure provider.

In accordance with an embodiment, a first step in the process is to create an operator tenancy for the PLC operator before the region and associated realms are turned over to them for subsequent management. The PLC operator then becomes the administrator of this tenancy with the ability to view and manage everything that happens within that region, including their customer accounts and usage by those customers of cloud resources.

Generally, once the region has been turned over or provided to the PLC operator, the cloud infrastructure provider cannot subsequently access the data within the operator tenancy unless the operator authorizes the cloud infrastructure provider to do so, for example, to provide troubleshooting of issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies for which the end customer will be the administrator. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

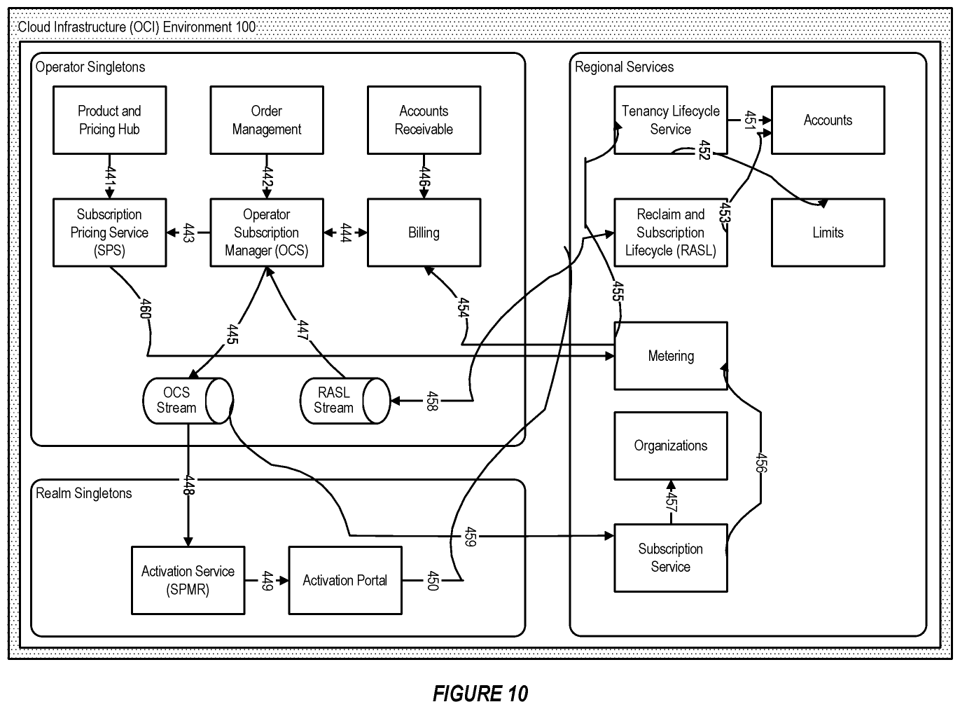

FIG. 9 further illustrates the use of private label cloud realms for use by tenants or customers of a cloud infrastructure environment in accordance with an embodiment.

As illustrated in FIG. 9, in accordance with an embodiment, an Oracle Cloud Subscriptions (OCS) service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process through which a subscription is created in a PLC realm, products can be selected from a product hub. Once an order is created, a subscription is created in OCS that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

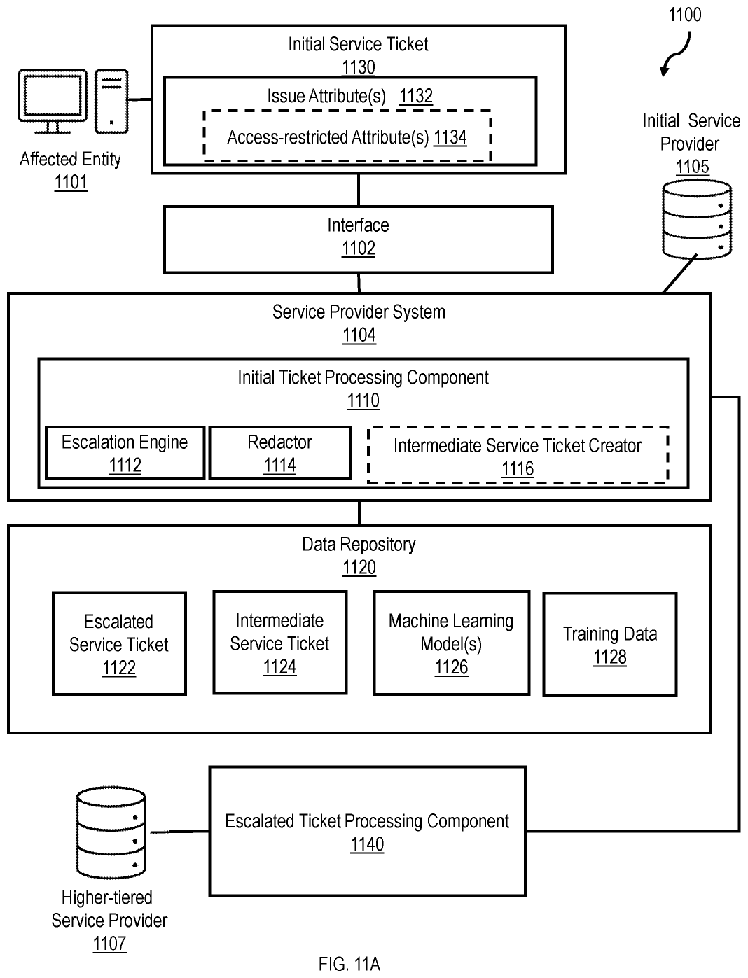

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, oracle Fusion Applications products, or other types of products or services that allow customers to subscribe to usage of those products or services.

In accordance with an embodiment, a subscription can include artifacts, such as products, commits, billing model, and state. The OCS service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added and existing prices changed. The price list has a full history, the latest version being the current rate card. Since some contracts may require a snapshot of the rate card be taken, the pricing service handles this by recording the time a customer's rate card is created, and then querying the price list at that time.

In accordance with an embodiment, the SPS or pricing service is responsible for providing information about products, global price lists, and end customer subscription specific price lists and discounts. For example, in accordance with an embodiment, the SPS can sync product information from an Oracle Fusion Product Hub and a global price list from an Oracle Fusion Pricing Hub.

In accordance with an embodiment, the OCS service operates as an upstream service to receive new order requests, for example, from an Oracle Fusion Order Management environment. The OCS service can provide subscription information to the SPS service. Subscription details like time of quote, configuration, and subscription type (Commitment, PayG) help SPS to determine an effective base price (Rate Card) for the subscription. The OCS service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules and uses this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creation from the Pricing Hub and call respective SPS pricing APIs.

In accordance with an embodiment, the system can also include an SPS core module that provides APIs to manage and access pricing entities. Pricing can be accessed by internal services, for example, an inline rating engine.

In accordance with an embodiment, the system can also include a rate card manager component. The SPS service maintains the single base price for a product at a given time. However, product prices for subscription are dependent on a base price at quote configuration time and price list change policy attributes of subscriptions. The SPS service internally maintains the price to be used for subscription using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that in line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the OCS component to create subscriptions, rate cards, and billing accounts. At 443, pricing configuration and pricing rules are sent to SPS for new orders. At 444, OCS is used to setup a billing account in the billing service or component. At 445, OCS publishes events to an OCI streaming component. At 446, a charge data is sent to an accounts receivable component to generate invoices. At 447, OCS consumes reclaim and subscription lifecycle (RASL) events from OCI streaming. At 448, an activation service reads the OCS event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads OCS event stream. At 459, the subscription service reads OCS event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 3. SERVICE ESCALATION SYSTEM ARCHITECTURE

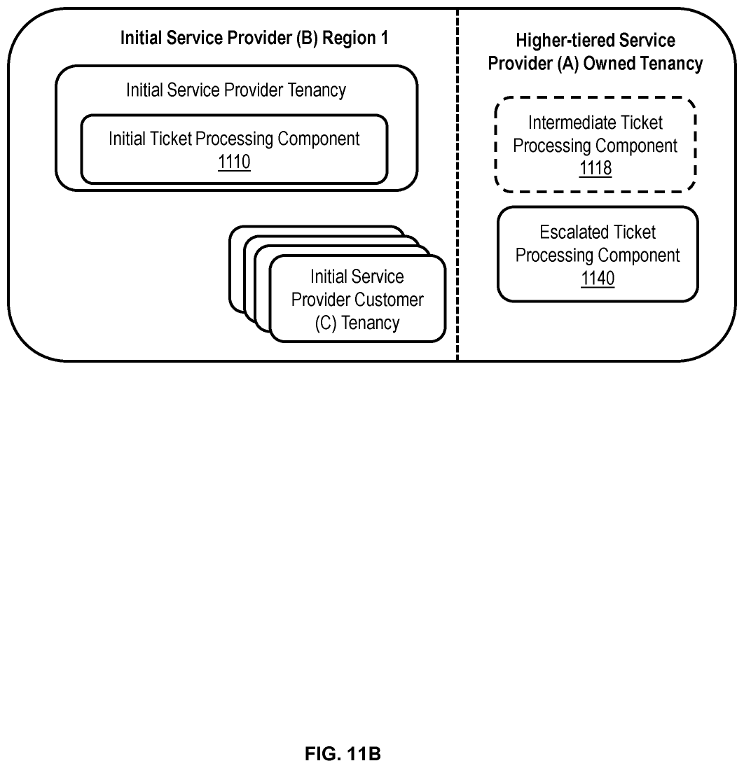

FIGS. 11A and 11B illustrate a system 1100 in accordance with one or more embodiments. As illustrated in FIG. 11A, system 1100 includes an interface 1102, a service provider system 1104, and an escalated ticket processing component 1140. The service provider system 1104 may include, or have access to, a data repository 1120. In one or more embodiments, the system 1100 may include more or fewer components than the components illustrated in FIG. 11A. The components illustrated in FIG. 11A may be local to or remote from each other. The components illustrated in FIG. 11A may be implemented in software and/or hardware. Each component may be distributed over multiple applications and/or machines. Multiple components may be combined into one application and/or machine. Operations described with respect to one component may instead be performed by another component.

In one or more embodiments, the service provider system 1104 refers to hardware and/or software configured to perform operations described herein for escalating and redacting service tickets from one service provider to another service provider. Examples of operations for escalating and redacting service tickets are described below with reference to FIG. 7.

The service provider system 1104 may be owned and/or operated by an initial service provider entity. In one or more embodiments, the initial service provider entity is a corporation, organization, enterprise, or other entity that provides a service to customer entities. The service may include providing access to software and/or hardware, as in a cloud service. In one or more embodiments, the initial service provider entity provides customer support to customer entities when an aspect of the service creates an issue for the customer that the initial service provider entity cannot resolve. The customer affected by the issue may be referred to herein as the affected entity 1101.

When an issue arises from the use of the service, the affected entity may create an initial service ticket 1130. The initial service ticket 1130 may include one or more issue attributes 1132. The issue attributes 1132 may include information that describes the issue, for example, an error code, a textual description of the issue, information identifying hardware components and/or software versions that were used when the issue occurred, and/or other conditions and settings present when the issue occurred. The issue attributes 1132 may also include access-restricted attributes 1134. Access-restricted attributes 1134 may include information that identifies the affected entity, confidential information of the affected entity, geographically restricted information, politically restricted information, or any other information that the affected entity does not want entities outside of the affected entity and the initial service provider to access.

The service provider system 1104 may include one or more functional components such as an initial ticket processing component 1110. The initial ticket processing component 1110 may include one or more functional components, such as an escalation engine 1112, a redactor 1114, and an optional intermediate service ticket creator 1116.

The initial ticket processing component 1110 may receive the initial service ticket 1130 via the interface 1102. The escalation engine 1112 may examine the issue attributes 1132 to determine whether the issue can be resolved by the initial service provider 1105 or whether a higher-tiered service provider 1107 is needed. The escalation engine 1112 may apply a machine learning model 1126, trained on training data 1128, to the initial service ticket 1130 to determine whether the issue requires escalation to a higher-tiered service provider. Machine learning models 1126 and training data 1128 are described below in Section 5, entitled “Machine Learning.”

When the escalation engine 1112 determines that the initial service ticket 1130 requires escalation, the initial ticket processing component 1110 may use the redactor 1114 to create an escalated service ticket 1122. The escalated service ticket 1122 may include enough of the issue attributes to identify the issue while omitting any identifying, confidential, or otherwise sensitive attributes of the affected entity. In one or more embodiments, the escalated service ticket 1122 is in a different format from the initial service ticket 1130, for example, if the higher-tiered service provider uses a different service ticket management system than the service provider system 1104. The redactor 1114 may apply a machine learning model 1126, trained on training data 1128, to the initial service ticket 1130, to determine what information to remove or anonymize from the initial service ticket. In one or more embodiments, the escalated service ticket 1122 is an anonymized version of the initial service ticket 1130. This may occur when the access-restricted set of attributes 1134 includes an identifier corresponding to the affected entity that is subsequently excluded from the escalated service ticket 1122.

In one or more embodiments, when the escalation engine 1112 determines that the initial service ticket 1130 requires escalation, the initial ticket processing component 1110 may use the intermediate service ticket creator 1116 and the redactor 1114 to generate an intermediate service ticket 1124. The intermediate service ticket 1124 may include enough of the issue attributes to identify the issue while omitting any identifying, confidential, or otherwise sensitive attributes of the affected entity. The intermediate service ticket 1124 is in the same format as the initial service ticket 1130 for use within the service provider system 1104. In one or more embodiments, the affected entity does not have access to the intermediate service ticket.

The initial service ticket, intermediate service ticket, and escalation service ticket may each include a reference that indexes the service tickets to each other. For example, if the initial service ticket includes a unique identifier, the intermediate service ticket may have its own unique identifier as well as a reference to the unique identifier of its corresponding initial service ticket. Similarly, the escalation service ticket may include a reference to the initial service ticket, the intermediate service ticket, or both. This allows the information pertaining to the issue to be communicated between the systems when the higher-tiered service provider cannot access the intermediate service ticket or the initial service ticket, and the affected entity and the initial service provider cannot access the escalation service ticket.

The higher-tiered service provider may control and operate an escalated ticket processing component 1140. The escalated ticket processing component 1140 may be configured to receive an escalated service ticket 1122 from the service provider system 1104. The higher-tiered service provider determines how to resolve the issue presented in the escalated service ticket 1122. If possible, the higher-tiered service provider may resolve the issue and update the escalated service ticket 1122 to reflect that the issue is resolved. If it is not possible for the higher-tiered service provider to resolve the issue, the higher-tiered service provider may update the escalated service ticket 1122 with instructions on how to resolve the issue for use by the initial service provider or by the affected entity. The escalated ticket processing component 1140 can then return the updated escalated service ticket 1122 to the initial service provider, or may return information indexed to the escalated service ticket 1122.

In one or more embodiments, a data repository 1120 is any type of storage unit and/or device (e.g., a file system, database, collection of tables, or any other storage mechanism) for storing data. Further, a data repository 1120 may include multiple different storage units and/or devices. The multiple different storage units and/or devices may or may not be of the same type or located at the same physical site. Further, a data repository 1120 may be implemented or executed on the same computing system as the service provider system 1104. Alternatively, or additionally, a data repository 1120 may be implemented or executed on a computing system separate from the service provider system 1104. The data repository 1120 may be communicatively coupled to the service provider system 1104 via a direct connection or via a network.

Information describing service tickets, machine learning models, and machine learning training data may be implemented across any of components within the system 1100. However, this information is illustrated within the data repository 1120 for purposes of clarity and explanation.

In an embodiment, the system 1100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 1102 refers to hardware and/or software configured to facilitate communications between a user, e.g., an affected entity, and the service provider system 1104. Interface 1102 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. Interface 1102 may include an interface that allows a user from the affected entity to create and submit an initial service ticket to the initial service provider. Interface 1102 may include an interface that allows a user from the affected entity to view a status of a submitted initial service ticket, including when the initial service ticket is resolved.

In an embodiment, different components of interface 1102 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 1102 is specified in one or more other languages, such as Java, C, or C++.

FIG. 11B illustrates an example where the higher-tiered service provider (entity A) is a cloud-service provider that offers cloud-service computing resources, so that entity A's customers, e.g., an initial service provider (entity B), can provide cloud services of their own. Entity B uses entity A's cloud-service computing resources to provide cloud services to customers C. The tenancy of entity B, including the initial ticket processing component 1110, and the tenancies of the customers C reside within premises owned and controlled by entity B.

Entity A owns a tenancy within a geographic region with entity B, which allows entity A to provide escalated service of its cloud-service computing resources. The escalated ticket processing component 1140 may exist within the entity A owned tenancy. Entity A does not have access to the entity B tenancy or to the customer C tenancies. Likewise, entity B and customers C do not have access to the entity A tenancy.

In one or more embodiments, the higher-tiered service provider may have an intermediate ticket processing component 1118. The intermediate ticket processing component 1118 may periodically poll or request the initial service provider for any new intermediate service tickets. When a new intermediate service ticket is found, the intermediate ticket processing component 1118 may generate the escalated service ticket and provide the escalated service ticket to the escalated ticket processing component 1140.

### 4. ESCALATING A SERVICE TICKET TO A THIRD PARTY

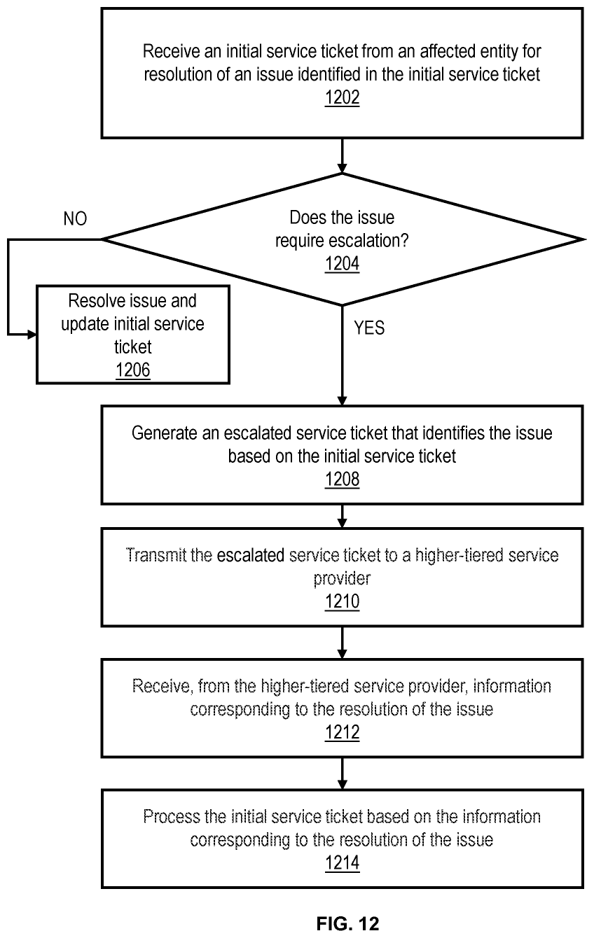

FIG. 12 illustrates an example set of operations for escalating and redacting an initial service ticket to a higher-tiered service provider in accordance with one or more embodiments. One or more operations illustrated in FIG. 12 may be modified, rearranged, or omitted altogether. Accordingly, the particular sequence of operations illustrated in FIG. 12 should not be construed as limiting the scope of one or more embodiments.

In one or more embodiments, the system receives an initial service ticket for resolution of an issue identified by the initial service ticket from an affected entity that is affected by the issue (Operation 1202). For example, a user at the affected entity may interact with a service request application provided by the initial service provider to provide information about the issue. The service request application may create the initial service ticket and submit the initial service ticket to the service provider system via an interface.

In one or more embodiments, the system determines whether the issue requires escalation (Operation 1204). The system may input the initial service ticket to an escalation machine learning model that processes the initial service ticket and outputs a determination of whether the issue identified in the initial service ticket is one that requires escalation.

In one or more embodiments, when the issue does not require escalation, the initial service provider resolves the issue and updates the initial service ticket (Operation 1206). The system may forward the initial service ticket to an appropriate service person or an automated repair system for resolution. The system may update the initial service ticket, for example, by changing a status field in the initial service ticket to “resolved”, by changing a Boolean field corresponding to a resolved statue from false to true, or by otherwise indicating that the issue is resolved. The system may also include notes or other indications about any steps taken to resolve the issue, such as installing an update or replacing a hardware component. A user at the affected entity may check the status of the initial service ticket, via an interface, to see that the issue is resolved.

In one or more embodiments, when the issue does require escalation, the system generates an escalated service ticket that identifies the issue based on the initial service ticket (Operation 1208). The system may make a copy of the initial service ticket and redact or anonymize the access-restricted attributes from the copy of the initial service ticket to create the escalated service ticket. Alternatively, the system may create a new escalated ticket and may copy or map the issue attributes from the initial service ticket to the escalated service ticket without copying the access-restricted attributes to the escalated service ticket.

The system may use a ticket escalation machine learning model to generate an intermediate service ticket and/or an escalated ticket based on either the initial service ticket or an intermediate service ticket. The ticket escalation machine learning model may be trained to identify and exclude the access-restricted attributes in the initial service ticket when generating the intermediate service ticket and/or the escalated service ticket. The ticket escalation machine learning model may also be trained to create the escalated service ticket in a format used by the higher-tiered service.

In one or more embodiments, the system transmits the escalated service ticket to a higher-tiered service provider (Operation 1210). The system may place the escalated service ticket into a queue for the higher-tiered service provider system. In some embodiments, the higher-tiered service provider system may pull or query the initial service provider system for any new escalated service tickets.

In one or more embodiments, the system receives information corresponding to the resolution of the issue from the higher-tiered service provider (Operation 1212). For example, the escalated service ticket may be returned to the system with an update to a status or other field indicating that the issue is resolved. The information may include notes or other description of steps taken to resolve the issue, such as software updates or hardware repair or replacement. The information may be received without the escalation service ticket, for example, as a file or other data structure indexed to the escalated service ticket.

In one or more embodiments, the system processes the initial service ticket based on the information corresponding to the resolution of the issue (Operation 1214). The system can use the index from the escalated service ticket to the intermediate service ticket or initial service ticket to identify which initial service ticket has been resolved. The system then updates the initial service ticket to reflect the resolution.

### 5. MACHINE LEARNING

A detailed example is described below for purposes of clarity. Components and/or operations described below should be understood as one specific example that may not be applicable to certain embodiments. Accordingly, components and/or operations described below should not be construed as limiting the scope of any of the claims.

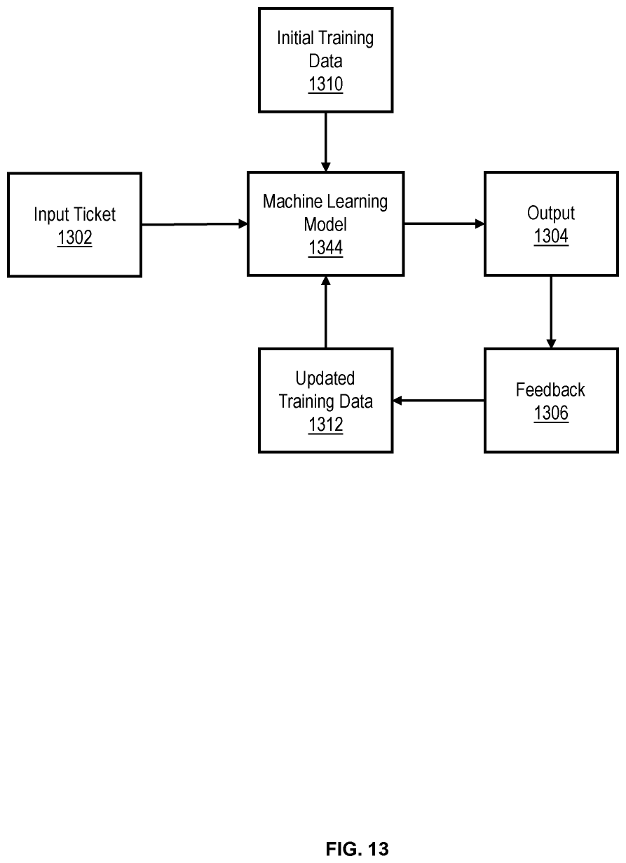

FIG. 13 illustrates a machine learning process according to one or more embodiments. A machine learning model 1344 may be iteratively trained on initial training data 1310 to map a set of input variables to an output variable. For an escalation machine learning model, the initial training data 1310 may include one or more sets of initial service tickets that are labeled according to whether the issue presented in the initial service ticket was escalated or not. For an escalated ticket generating machine learning model, the initial training data may include one or more sets of initial service tickets and their corresponding intermediate service tickets and/or escalated service tickets.

Once trained initially, an escalation machine learning model may act on an input ticket 1302, which may be an initial service ticket, and the output 1304 may be a label or other indication that the initial service ticket should be escalated or not escalated. For an escalated ticket generating machine learning model, the input ticket 1302 may be an initial service ticket or an intermediate service ticket, and the escalated ticket generating machine learning model may output an intermediate service ticket or an escalated service ticket.

The training data may be updated based on, for example, feedback 1306 on the accuracy of the current machine learning model 1344. Updated training data 1312 is fed back into the machine learning algorithm, which in turn updates the machine learning model 1344.

A machine learning model 1344 is trained such that the model best fits the datasets of training data to the labels or outputs of the training data. Additionally, or alternatively, machine learning model 1344 is trained such that when the model is applied to the datasets of the training data, a maximum number of results determined by the model matches the labels or outputs of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 6. PRACTICAL APPLICATIONS, ADVANTAGES, AND IMPROVEMENTS

In one or more embodiments, the systems described herein make it possible for an entity that provides services to customers to escalate service issues that the entity cannot resolve to another third-party entity without exposing customer data or identifying information to the third party.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving an initial service ticket, at an initial service provider, for resolution of an issue identified by the initial service ticket, from an affected entity that is affected by the issue, wherein the initial service ticket comprises an access-restricted set of attributes of the affected entity, the access-restricted set of attributes including one or more attributes;
based on the initial service ticket, generating, at the initial service provider, an escalated service ticket that identifies the issue, wherein the escalated service ticket does not include the access-restricted set of attributes of the affected entity;
transmitting the escalated service ticket to a higher-tiered service provider, wherein a higher-tiered service provider is not authorized to access the access-restricted set of attributes comprised in the initial service ticket;
in response to transmitting the escalated service ticket: receiving, from the higher-tiered service provider, information corresponding to the resolution of the issue; and
processing the initial service ticket based on the information corresponding to the resolution of the issue.

2. The one or more non-transitory computer readable media of claim 1, wherein the escalated service ticket is an anonymized version of the initial service ticket and wherein the access-restricted set of attributes, which are comprised in the initial service ticket but not in the escalated service ticket, include an identifier corresponding to the affected entity.

3. The one or more non-transitory computer readable media of claim 1, wherein generating the escalated service ticket comprises:
generating a feature vector based on (a) the initial service ticket or (b) an intermediate service ticket generated based on the initial service ticket; and
applying a machine learning model to the feature vector to generate the escalated service ticket.

4. The one or more non-transitory computer readable media of claim 1, wherein generating the escalated service ticket based on the initial service ticket comprises:
obtaining an intermediate service ticket that was generated by redacting information from the initial service ticket; and
generating the escalated service ticket based on the intermediate service ticket,
wherein the higher-tiered service provider is not permitted to and cannot access the initial service ticket or the intermediate service ticket.

5. The one or more non-transitory computer readable media of claim 1, the operations further comprising:
generating a feature vector based on the initial service ticket;
applying an escalation machine learning model to the feature vector to determine that the issue identified in the initial service ticket requires escalation to the higher-tiered service provider; and
generating the escalated service ticket responsive to the determination.

6. The one or more non-transitory computer readable media of claim 1, wherein the affected entity is not permitted to and cannot access the escalated service ticket.

7. The one or more non-transitory computer readable media of claim 1, wherein the initial service ticket is in a first format and the escalated service ticket is in a second format.

8. A method, comprising:
receiving an initial service ticket, at an initial service provider, for resolution of an issue identified by the initial service ticket, from an affected entity that is affected by the issue, wherein the initial service ticket comprises an access-restricted set of attributes of the affected entity, the access-restricted set of attributes including one or more attributes;
based on the initial service ticket, generating, at the initial service provider, an escalated service ticket that identifies the issue, wherein the escalated service ticket does not include the access-restricted set of attributes of the affected entity;
transmitting the escalated service ticket to a higher-tiered service provider, wherein a higher-tiered service provider is not authorized to access the access-restricted set of attributes comprised in the initial service ticket;
in response to transmitting the escalated service ticket: receiving, from the higher-tiered service provider, information corresponding to the resolution of the issue; and
processing the initial service ticket based on the information corresponding to the resolution of the issue;
wherein the method is performed by at least one device comprising a hardware processor.

9. The method of claim 8, wherein the escalated service ticket is an anonymized version of the initial service ticket and wherein the access-restricted set of attributes, that are comprised in the initial service ticket but not in the escalated service ticket, include an identifier corresponding to the affected entity.

10. The method of claim 8, wherein generating the escalated service ticket comprises:
generating a feature vector based on (a) the initial service ticket or (b) an intermediate service ticket generated based on the initial service ticket; and
applying a machine learning model to the feature vector to generate the escalated service ticket.

11. The method of claim 8, wherein generating the escalated service ticket based on the initial service ticket comprises:
obtaining an intermediate service ticket that was generated by redacting information from the initial service ticket; and
generating the escalated service ticket based on the intermediate service ticket,
wherein the higher-tiered service provider is not permitted to and cannot access the initial service ticket or the intermediate service ticket.

12. The method of claim 8, the operations further comprising:
generating a feature vector based on the initial service ticket;
applying an escalation machine learning model to the feature vector to determine that the issue identified in the initial service ticket requires escalation to the higher-tiered service provider; and
generating the escalated service ticket responsive to the determination.

13. The method of claim 8, wherein the affected entity is not permitted to and cannot access the escalated service ticket.

14. A system comprising:
at least one device including a hardware processor;
the system being configured to perform operations comprising:
receiving an initial service ticket, at an initial service provider, for resolution of an issue identified by the initial service ticket, from an affected entity that is affected by the issue, wherein the initial service ticket comprises an access-restricted set of attributes of the affected entity, the access-restricted set of attributes including one or more attributes;
based on the initial service ticket, generating, at the initial service provider, an escalated service ticket that identifies the issue, wherein the escalated service ticket does not include the access-restricted set of attributes of the affected entity;
transmitting the escalated service ticket to a higher-tiered service provider, wherein a higher-tiered service provider is not authorized to access the access-restricted set of attributes comprised in the initial service ticket;
in response to transmitting the escalated service ticket: receiving, from the higher-tiered service provider, information corresponding to the resolution of the issue; and
processing the initial service ticket based on the information corresponding to the resolution of the issue.

15. The system of claim 14, wherein the escalated service ticket is an anonymized version of the initial service ticket and wherein the access-restricted set of attributes, that are comprised in the initial service ticket but not in the escalated service ticket, include an identifier corresponding to the affected entity.

16. The system of claim 14, wherein generating the escalated service ticket comprises:
generating a feature vector based on (a) the initial service ticket or (b) an intermediate service ticket generated based on the initial service ticket; and
applying a machine learning model to the feature vector to generate the escalated service ticket.

17. The system of claim 14, wherein generating the escalated service ticket based on the initial service ticket comprises:
obtaining an intermediate service ticket that was generated by redacting information from the initial service ticket; and
generating the escalated service ticket based on the intermediate service ticket,
wherein the higher-tiered service provider is not permitted to and cannot access the initial service ticket or the intermediate service ticket.

18. The system of claim 14, the operations further comprising:
generating a feature vector based on the initial service ticket;
applying an escalation machine learning model to the feature vector to determine that the issue identified in the initial service ticket requires escalation to the higher-tiered service provider; and
generating the escalated service ticket responsive to the determination.

19. The system of claim 14, wherein the affected entity is not permitted to and cannot access the escalated service ticket.

20. The system of claim 14, wherein the initial service ticket is in a first format and the escalated service ticket is in a second format.
